(19) United States
(12) Patent Application Publication
(10) Pub. No.: US 2015/0293845 A1
(43) Pub. Date: Oct. 15, 2015

(54) MULTI-LEVEL MEMORY HIERARCHY

(71) Applicant: ADVANCED MICRO DEVICES, INC., Sunnyvale, CA (US)

(72) Inventors: Lisa R. Hsu, Raleigh, NC (US); James M. O'Connor, Austin, TX (US); Vilas K. Sridharan, Brookline, MA (US); Gabriel H. Loh, Bellevue, WA (US); Nuwan S. Jayasena, Sunnyvale, CA (US); Bradford M. Beckmann, Redmond, WA (US)

(73) Assignee: ADVANCED MICRO DEVICES, INC., Sunnyvale, CA (US)

(21) Appl. No.: 14/250,474

(22) Filed: Apr. 11, 2014

(51) Int. Cl. G06F 12/08; G06F 12/10

(52) U.S. Cl. CPC G06F 12/0811; G06F 12/1009; G06F 2212/283; G06F 2212/651

(57) ABSTRACT

Described is a system and method for a multi-level memory hierarchy. Each level is based on different attributes including, for example, power, capacity, bandwidth, reliability, and volatility. In some embodiments, the different levels of the memory hierarchy may use an on-chip stacked dynamic random access memory, (providing fast, high-bandwidth, low-energy access to data) and an off-chip non-volatile random access memory, (providing low-power, high-capacity storage), in order to provide higher-capacity, lower power, and higher-bandwidth performance. The multi-level memory may present a unified interface to a processor so that specific memory hardware and software implementation details are hidden. The multi-level memory enables the illusion of a single-level memory that satisfies multiple conflicting constraints. A comparator receives a memory address from the processor, processes the address and reads from or writes to the appropriate memory level. In some embodiments, the memory architecture is visible to the software stack to optimize memory utilization.

### TECHNICAL FIELD

The disclosed embodiments are generally directed to memory systems.

### BACKGROUND

The increasing data storage needs of emerging applications can be extremely difficult to support using standard configurations of memory. For example, systems with terabytes (or petabytes) of memory need fast access to memory within low power-envelopes. However, current solutions to large memory requirements include adding more dual in-line memory module (DIMMs) to a system or stacking dynamic random access memory (DRAM) in a single package. Both of these solutions face various scaling issues, (for example, with respect to power), as memory needs in the big data application space continue to accelerate.

### SUMMARY OF ONE OR MORE EMBODIMENT(S)

Described herein are embodiments including, for example only, a system and method for a multi-level memory hierarchy. The memory is architected with multiple levels, where a level is based on different attributes including, for example, power, capacity, bandwidth, reliability, and volatility. In some embodiments, the different levels of the memory hierarchy may use an on-chip stacked dynamic random access memory (DRAM), (which provides fast, high-bandwidth, low-energy access to data) and an off-chip non-volatile random access memory (NVRAM), (which provides low-power, high-capacity storage), in order to provide higher-capacity, lower power, and higher-bandwidth performance. The multi-level memory may present a unified interface to a processor so that specific memory hardware and software implementation details are hidden. The multi-level memory enables the illusion of a single-level memory that satisfies multiple conflicting constraints. A comparator, for example, can receive a memory address from the processor, process the address and read from or write to the appropriate memory level. In some embodiments, the memory architecture is visible to the software stack to optimize memory utilization.

### BRIEF DESCRIPTION OF THE DRAWINGS

A more detailed understanding may be had from the following description, given by way of example in conjunction with the accompanying drawings wherein:

FIG. 1 is a high level block diagram of a multi-level memory system in accordance with some embodiments;

FIG. 2 is a block diagram of a multi-level memory system in accordance with some embodiments;

FIG. 3 is a flow chart for use with a multi-level memory system in accordance with some embodiments; and

FIG. 4 is a block diagram of an example device in which one or more disclosed embodiments may be implemented.

### DETAILED DESCRIPTION OF ONE OR MORE EMBODIMENT(S)

Described is a system and method for a multi-level memory hierarchy. The multi-level memory is architected with multiple levels, where a level is based on different attributes including, for example, power, capacity, bandwidth, reliability, and volatility. The different levels of the memory hierarchy may use on-chip stacked dynamic random access memory (DRAM), (which provides fast, high-bandwidth, low-energy access to data), an off-chip non-volatile random access memory (NVRAM), (which provides low-power, high-capacity storage), in order to provide higher-capacity, lower power, and higher-bandwidth performance, and other memory types.

The multi-level memory may present a unified or single interface to a processor so that specific memory hardware and software implementation details are hidden. Effectively, it is a single logical structure. Presently, an operating system (OS), apart from standard main memory, needs device drivers for each type of additional memory or storage, (for example, NVRAM), that is connected to the processor so that the OS can talk to each type of memory. Each memory type has specific characteristics and vendor-to-vendor differences that must be accounted for. In particular, each memory type is a separate physical and logical structure. The multi-level memory system provides greater flexibility to meet arbitrary constraints and performance difficult to achieve in a uniform, single-level hierarchy. In some embodiments, users of the processor and multi-level memory may want access or know details about the different levels in the multi-level memory to optimize performance.

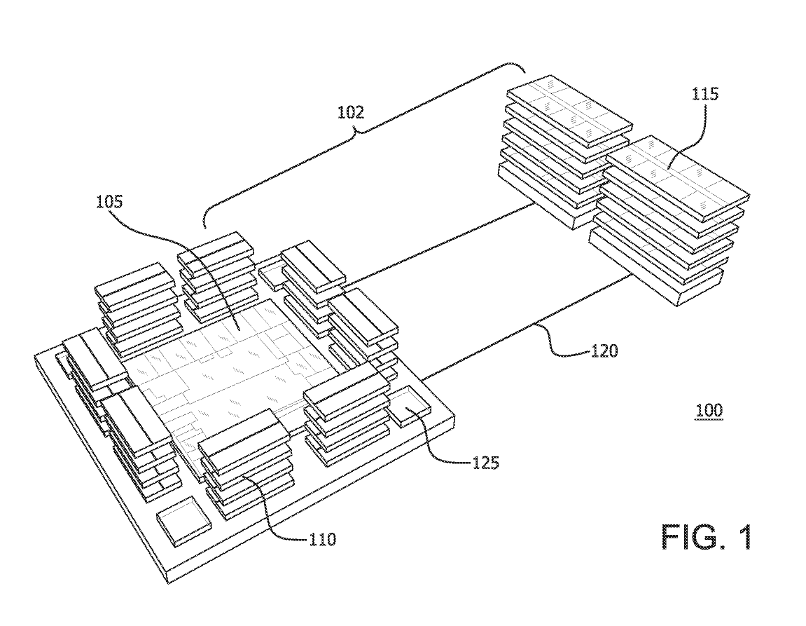

FIG. 1 is a high level block diagram of a system 100 with a multi-level memory 102. The system 100 may include, for example, a processor 105 in communication with the multi-level memory 102 which includes an in-package stacked dynamic random access memory (DRAM) 110, (a first memory level), and with off-chip non-volatile memory (NVM) RAM (NVRAM) stacks 115, (a second memory level). In some embodiments, the two levels are connected via an optical link 120 using in-package photonics 125. Although stacked memories are shown in FIG. 1, the memory on either level may not be stacked, may be DRAM or any form of NVRAM, including but not limited, to Phase-change memory (PCM), Spin-Torque Transfer Magnetoresistive Random Access Memory (STT MRAM), and titanium dioxide memristors. The memory levels may be on different chips, and may be connected by various links, including but not limited to, optical, electrical, or wireless. It is understood that the multi-level memory 102 may include any number of memory levels based on different types of attributes as described herein. The multi-level memory 102 has associated address ranges used by an operating system to allocate the memory resources for the system 100 as described herein. It is understood that the system 100 may include additional components not shown in FIG. 1.

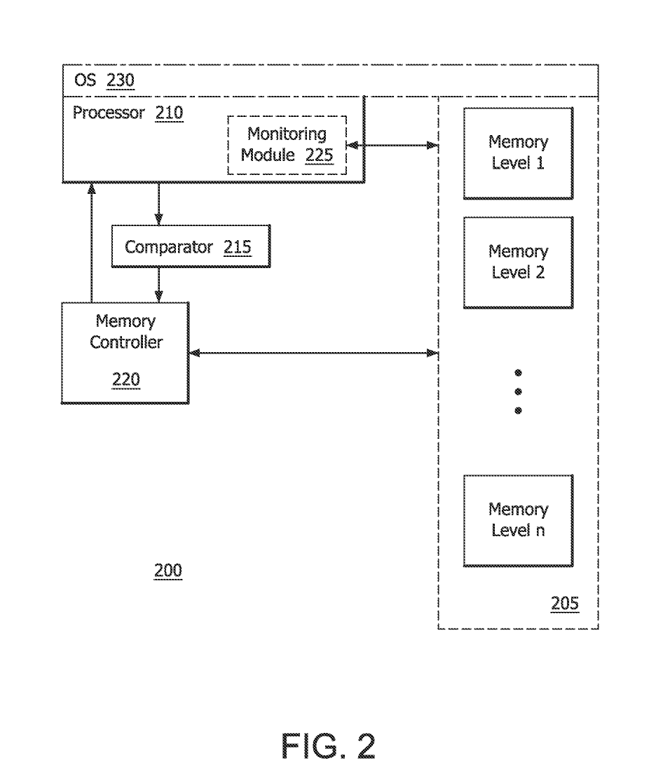

FIG. 2 is a block diagram of a system 200 with a multi-level memory 205 which may include memory level 1, memory level 2 . . . memory level n and have associated address ranges. For example, multi-level memory 205 may have addresses from 0 . . . n, where memory level 1 is addresses 0 . . . x, memory level 2 is addresses x+1 . . . y and memory level n is addresses y+1 . . . n. The system 200 includes a processor 210 which interacts with multi-level memory 205 via a comparator 215 and a memory controller 220. The memory controller 220 may include multiple memory controllers corresponding to memory level 1, memory level 2 . . . memory level n. The processor 210 includes a monitoring module 225. In some embodiments, monitoring module 225 is implemented as a standalone or dedicated processor, for example, a microprocessor. In some embodiments, the monitoring module 225 may be implemented as dedicated tables in processor 210 that are not accessible by applications. As described herein below, monitoring module 225 may be used to measure certain characteristics about memory usage that may be used as input to policy decisions. The system 200 includes an operating system (OS) 230, (residing in multi-level memory 205), which manage resources, (including memory resources) for system 100 and in particular, processor 210, and provides common services for computer programs/applications executing on system 200. In some embodiments, OS 230 uses data structures to store and track addresses associated with memory availability/usage in multi-level memory 205, attributes associated with each memory level 1, memory level 2 . . . memory level n of multi-level memory 205 and other like information. It is understood that the system 200 may include additional components not shown in FIG. 2.

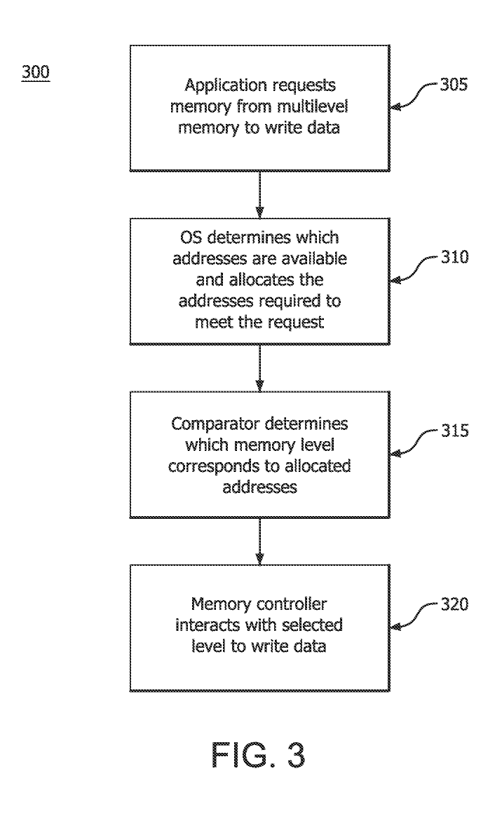

FIG. 3 is an example flowchart 300 for writing data using a multi-level memory as shown, for example, in system 200. In an example, an application or program running on system 200 requests memory from multi-level memory 205 to write or store data (305). The request may include needed memory attributes. The OS 230 will then determine, (using data structures, for example), which addresses are available and allocate the addresses required to meet the request (310). In some examples, the memory request may include particular memory attributes or specific properties. The OS 230 will then match the available addresses with the requested memory attributes or specific properties. The comparator 215 will then receive the allocated addresses and determine which of memory level 1, memory level 2 . . . memory level n in multi-level memory 205 maps to the allocated addresses (315). The memory controller 220 will then receive the data and interact with the determined or selected memory level in multi-level memory 205 to write the data (320). In an example read operation, the flow may be similar in that a comparator 215 may determine the proper memory level based on the address from OS 230. The memory controller 220 may instead request the data from the selected memory and forward it to the processor 210.

The multi-level memory shown in FIGS. 1 and 2 supports high-bandwidth, low-latency, and low-energy access to a high-capacity body of memory. For example, the levels of the multi-level memory can have particular memory attributes or specific properties. A system using the multi-level memory provides an ability to use the following methods and structures to efficiently manage memory transactions. In some embodiments, large page sizes may be used to alleviate the overhead of managing petabytes of data, (for example, by decreasing the number of entries in a page table). The page size, for example, is an attribute or property of one level of the multi-level memory. Traditionally, page sizes have been on the order of 4 kilobytes (KBs). For example, if the volume of data was 4 gigabytes (GBs), the system may use 1 million pages and the page table may have 1 million entries. If there 100 processes running at the same time, the page table may have 100 million entries. If the page size was 4 GB, then the page table may only have 100 entries, which is much more manageable in terms of overhead processing. In some embodiments, multiple granularities of page sizes may be used to better manage data movement overheads. For example, 512 megabytes (MBs) pages may be used on a first level and 4 GBs pages may be used on a second level. The granularity may depend on the needs of the application. In other words, granularity is an attribute in accordance with some embodiments.

In some embodiments, page tables may be modified to better handle large and/or varying page sizes. For example, page tables may be segmented such that a page table entry may be for a large page size, (for example, 4 GB), but have bit fields indicating the status and/or validity of smaller granularities within the large page. This may permit grouping together certain pages and indicate in the bit fields the differences between the pages. In other words, page tables and the different embodiments discussed herein are attributes in accordance with some embodiments.

In some embodiments, page tables may be modified to include reliability and volatility information. For example, DRAM pages may be marked as volatile. In another example, NVRAM pages may be marked with an age field to track the level of volatility. In another example, DRAM pages may be marked as having a different level of reliability than NVRAM pages based on the hardware characteristics to facilitate OS decisions for storing critical data. This may permit tracking of attributes that may change over time. If a particular memory level is written to frequently, the memory level may have a greater chance of failing.

In some embodiments, page table fields can be used to indicate the permanency of the associated data. This may be used, for example, to use lower write currents to perform writes in the NVRAM if the data is not expected to be live for a long period, (writing of intermediate or partial results). For some memory types, there is a trade-off between the amount of power used to perform a write and how long the data will stay in memory. At one power level, the data may survive for decades but at another power level, the data may last only one day, (decreased power usually equals decreased reliability). In some embodiments, a similar optimization may be made for reads if some memory levels only support destructive reads which require more energy to rewrite the read values, and others did not. In that situation, frequently read data may be allocated to the memory levels that require lower read energy. All of these characteristics or attributes can be captured in the page table bit fields and/or data structures as transient or temporary so that the OS can take advantage of these attributes.

As shown in FIG. 2, a monitoring module or apparatus may be used to measure certain characteristics about memory usage that may be used as an input to policy decisions. For example, hardware counters may be used to count the frequency of usage of and/or writes to certain pages. This will influence the decision of whether to move the page from a second level to a first level.

The system may include hardware or software mechanisms to remap pages from a first level to a second, and vice versa. For example, given a decision by the OS to move a page or object, (where the object is the data), from the first level to the second level, there may be an OS subroutine that initiates and performs the move or there may be device interrupts to hardware assist logic which performs the move. The hardware assist logic can be in the form of dedicated logic on the processor side or on the off-chip stack logic layer. This page remapping can be performed autonomously with the remapping managed entirely within the associated memory level, (maintaining checkpoints, performing wear-leveling, and the like). These functions may involve coordination between levels and can be performed by direct memory access (DMA) engines directly integrated into the processor. The DMA engine may move the page or object from a source, (for example, a first level), to a destination, (for example, a second level).

In some embodiments, multiple types of memory are implemented within the same level. For example, static RAM (SRAM) and/or DRAM may be used in conjunction with off-chip NVRAM in a software-visible or software transparent manner to provide, for example, write combining functionality.

In some embodiments, non-volatile memory may be coupled with a safety RAM. The safety RAM acts as a cache to increase performance or as a write buffer to limit the number of writes to the non-volatile memory and increase the lifetime of the non-volatile memory. In this instance, the system believes it is writing to the non-volatile memory but there is an extra RAM structure that helps performance and lifetime. The safety RAM discussed herein is an attribute in accordance with some embodiments.

In some embodiments, compression, encryption, error-resilience methods and other such operations may be applied selectively and differently at each level of the multi-level memory. These methods are attributes in accordance with some embodiments.

In some embodiments, allocation of memory in the various levels of the multi-level memory to applications and data structures may be driven by application/data characteristics and/or quality of service (QoS) requirements. For example, high-priority applications may be allocated the bulk of the memory in “fast” levels while lower priority applications may be allocated “slow” memory, (except when fast memory is unused). In another example, applications/data with real-time constraints may be allocated to levels with predictable access latencies. In another example, small data regions that are frequently accessed, (such as the stack, code, data used by synchronization, and the like) can be allocated into the fast levels while larger data regions that are less frequently accessed, (such as large heap objects), can be allocated into slower memory levels. The above are attributes in accordance with some embodiments.

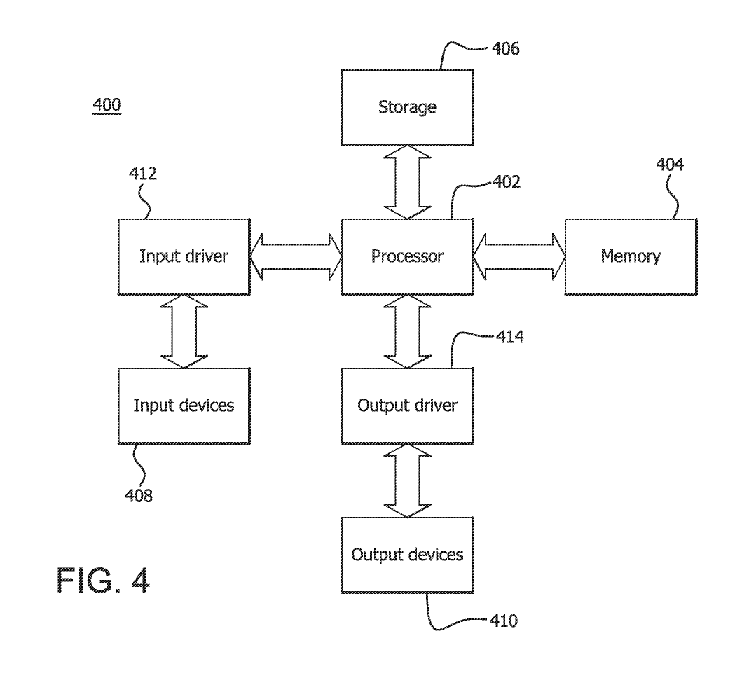

FIG. 4 is a block diagram of an example device 400 in which one or more disclosed embodiments may be implemented. The device 400 may include, for example, a computer, a gaming device, a handheld device, a set-top box, a television, a mobile phone, or a tablet computer. The device 400 includes a processor 402, a memory 404, a storage device 406, one or more input devices 408, and one or more output devices 410. The device 400 may also optionally include an input driver 412 and an output driver 414. It is understood that the device 400 may include additional components not shown in FIG. 4.

The processor 402 may include a central processing unit (CPU), a graphics processing unit (GPU), a CPU and GPU located on the same die, or one or more processor cores, wherein each processor core may be a CPU or a GPU. The memory 404 may be located on the same die as the processor 402, or may be located separately from the processor 402. The memory 404 may include a volatile or non-volatile memory, for example, random access memory (RAM), dynamic RAM, or a cache. The memory 404 may be a multi-level memory that is defined by attributes and used as described herein.

The storage 406 may include a fixed or removable storage, for example, a hard disk drive, a solid state drive, an optical disk, or a flash drive. The input devices 408 may include a keyboard, a keypad, a touch screen, a touch pad, a detector, a microphone, an accelerometer, a gyroscope, a biometric scanner, or a network connection (e.g., a wireless local area network card for transmission and/or reception of wireless IEEE 802 signals). The output devices 410 may include a display, a speaker, a printer, a haptic feedback device, one or more lights, an antenna, or a network connection (e.g., a wireless local area network card for transmission and/or reception of wireless IEEE 802 signals).

The input driver 412 communicates with the processor 402 and the input devices 408, and permits the processor 402 to receive input from the input devices 408. The output driver 414 communicates with the processor 402 and the output devices 410, and permits the processor 402 to send output to the output devices 410. It is noted that the input driver 412 and the output driver 414 are optional components, and that the device 400 will operate in the same manner if the input driver 412 and the output driver 414 are not present.

In general, in some embodiments, a system comprises a multi-level memory and a processor. Each level is defined by at least one attribute. The processor makes decisions and interacts with the multi-level memory based on the attribute(s). In some embodiments, the system also includes a comparator that compares a memory address received from the processor to a plurality of memory address ranges to determine which level corresponds to the memory address. The memory address being based on the attribute(s). In some embodiments, the system further includes a plurality of memory controllers coupled to the multi-level memory and the comparator. The processor operates independent of the plurality of memory controllers.

In some embodiments, the system further includes a monitoring module that measures certain characteristics about memory usage that are used as input to policy decisions. The processor matches memory requests against each level and associated attribute(s) in the multi-level memory. In some embodiments, multiple page sizes are used with respect to the multi-level memory. The page tables include fields indicating at least one of status and validity of smaller page granularities within a page. In some embodiments, certain smaller page granularities are grouped together and the fields indicate differences between the smaller page granularities. The page tables include may include reliability, volatility, permanency and write frequency information. In some embodiments, the pages are remapped from one level to another level. In some embodiments, a level(s) includes multiple types of memory. In some embodiments, the system further includes a safety memory coupled to certain levels of the multi-level memory to reduce the number of writes to the certain levels. The safety memory is transparent to the processor.

In some embodiments, a method for writing data includes receiving, from an application, a request for memory in a multi-level memory. An available address is determined based on requested memory attributes and allocated to the request. The available address is compared to address ranges to determine a level of the multi-level memory and data is written to the determined level. In some embodiments, certain characteristics about memory usage are monitored that are used as input to policy decisions. Data from multiple writes may be buffered prior to writing to certain levels of the multi-level memory to reduce the number of writes to the certain levels.

It should be understood that many variations are possible based on the disclosure herein. Although features and elements are described above in particular combinations, each feature or element may be used alone without the other features and elements or in various combinations with or without other features and elements.

The methods provided may be implemented in a general purpose computer, a processor, or a processor core. Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine. Such processors may be manufactured by configuring a manufacturing process using the results of processed hardware description language (HDL) instructions and other intermediary data including netlists (such instructions capable of being stored on a computer readable media). The results of such processing may be maskworks that are then used in a semiconductor manufacturing process to manufacture a processor which implements aspects of the present invention.

The methods or flow charts provided herein may be implemented in a computer program, software, or firmware incorporated in a computer-readable storage medium for execution by a general purpose computer or a processor. Examples of computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

What is claimed is:

1. A system, comprising:
a multi-level memory, wherein each level is defined by at least one attribute; and
a processor configured to interact with the multi-level memory based on the at least one attribute.

2. The system of claim 1, further comprising:
a comparator configured to compare a memory address received from the processor to a plurality of memory address ranges to determine which level corresponds to the memory address, the memory address based on the at least one attribute.

3. The system of claim 2, further comprising:
a plurality of memory controllers coupled to the multi-level memory and the comparator, wherein the processor is configured to operate independent of the plurality of memory controllers.

4. The system of claim 1, further comprising:
a monitoring module configured to measure certain characteristics about memory usage that are used as input to policy decisions.

5. The system of claim 1, wherein the processor is configured to match memory requests against each level and associated attribute in the multi-level memory.

6. The system of claim 1, wherein page tables include fields indicating at least one of status and validity of smaller page granularities within a page.

7. The system of claim 6, wherein certain smaller page granularities are grouped together and the fields indicate differences between the smaller page granularities.

8. The system of claim 1, wherein page tables include at least one of reliability, volatility, permanency and write frequency information.

9. The system of claim 1, wherein at least one level includes multiple types of memory.

10. The system of claim 1, further comprising:
a safety memory coupled to certain levels of the multi-level memory to reduce number of writes to the certain levels.

11. A method for writing data, comprising:
receiving, from an application, a request for memory in a multi-level memory;
determining an available address based on requested memory attributes;
allocating the available address to the request;
comparing the available address to address ranges to determine a level of the multi-level memory; and
writing data to determined level.

12. The method of claim 11, further comprising:
monitoring certain characteristics about memory usage that are used as input to policy decisions.

13. The method of claim 11, wherein page tables include fields indicating at least one of status and validity of smaller page granularities within a page.

14. The method of claim 11, wherein certain smaller page granularities are grouped together and the fields indicate differences between the smaller page granularities.

15. The method of claim 11, wherein page tables include at least one of reliability, volatility, permanency and write frequency information.

16. The method of claim 11, wherein pages are remapped from one level to another level.

17. The method of claim 11, wherein at least one level includes multiple types of memory.

18. The method of claim 11, further comprising:
buffering data from multiple writes prior to writing to certain levels of the multi-level memory to reduce number of writes to the certain levels.

19. A computer-readable storage medium configured to store a set of instructions used for manufacturing a device, wherein the device comprises:
a multi-level memory, wherein each level is defined by at least one attribute; and
a processor configured to make decisions and interact with the multi-level memory based on the at least one attribute.

20. The computer-readable storage medium of claim 19, wherein the instructions are at least one of Verilog data instructions and hardware description language (HDL) instructions.
